(19) United States
(12) Patent Application Publication
(10) Pub. No.: US 2026/0151866 A1
(43) Pub. Date: Jun. 4, 2026

(54) QUICK-CHANGE MECHANISM AND TOOL CHANGING METHOD FOR REALIZING VARIABLE DIAMETER TURNING BY MACHINE TOOLS

(71) Applicant: DALIAN UNIVERSITY OF TECHNOLOGY, Dalian (CN)

(72) Inventors: Hongwei SUN, Dalian (CN); Zhi WANG, Dalian (CN); Qingkai JIANG, Dalian (CN); Fuyan SUN, Dalian (CN); Hui YAO, Dalian (CN)

(21) Appl. No.: 19/364,195

(22) Filed: Oct. 21, 2025

(30) Foreign Application Priority Data
Sep. 12, 2025 (CN) 202511303039.5

(51) Int. Cl. B23Q 3/155; B23B 13/02

(52) U.S. Cl. CPC B23Q 3/15503; B23B 13/02

(57) ABSTRACT

A quick-change mechanism and tool changing method for realizing variable diameter turning by machine tools. The quick-change mechanism enables a turning tool 10 of a CNC machine tool to move along a U-axis direction and rotate around the axis of a spindle. Therefore, a workpiece to be machined is subjected to variable diameter turning by active motion of the turning tool 10 without rotational motion of the workpiece, thus realizing machining of a conical surface. The tool changing method is implemented by the motion coordination among variable diameter turning tool head units, the power seat unit, the spindle mounting unit, a variable diameter turning tool head grasping mechanism, a variable diameter turning tool head unit storing bank and a power seat unit storing plate is realized.

### TECHNICAL FIELD

The present invention belongs to the field of turning by CNC machine tools, and relates a quick-change mechanism and tool changing method for realizing variable diameter turning by machine tools.

### BACKGROUND

Horizontal turning and milling compound machining center machine tools, as core equipment in modern manufacturing industry, have seen a continuous increase in market demand. The diverse demands of the market have promoted various technological innovations in machine tools. A turning function of a CNC machine tool is always fixed diameter turning, and a center of gyration of a machined part is concentric with a spindle of a workpiece; but milling is mainly dependent on a coordinate point path method. When dealing with machining of a complex curved surface, a tool path planning method is usually adopted for machining, for example, a tool path planning method combining equidistant cutting algorithm and path optimization technology and a cutting strategy combining layer-by-layer cutting and equal-height cutting proposed in the paper of Research on Machining Processes of Complex Curved Surfaces of Aircraft Parts Based on Computer Numerical Control Technology by Yuan Yu. Tool path planning is a core link in the machining of the complex curved surface, which directly affects machining accuracy, efficiency and surface quality. It can be seen that the larger the number of the tool paths is, the more complex the curve will be; and the larger the number of moving axes involved in linkage is, the worse the path optimization effect will be, and the poorer the surface quality of a machined product will be. Therefore, when machining a complex surface such as a conical surface, reducing the number of moving axes involved in linkage and the complexity of tool path formation can better reduce machining errors and improve the indicators such as machining efficiency and surface roughness.

Thus, it is proposed to configure a variable diameter turning function in a spindle component of a tool, and realize conical turning by combining the rotation of the tool and the motion of a tool tip position. A variable diameter turning device is controlled by a CNC system to realize linkage interpolation with a numerical control axis, which can be used for machining various gyroscopic curved surfaces, inner and outer circles, end faces, threads, etc. With such a function, a traditional multi-axis large-displacement linkage method for milling a curved surface is optimized into a single-axis unidirectional motion, which reduces the probability of poor machining quality caused by motion errors. The present invention adopts a quick-change mechanism and a specific tool changing method to realize tool grasping as required by a working condition, and realize tool taking in use and storage in bank in idle.

### SUMMARY

To solve the above problems in the prior art, the present invention provides a quick-change mechanism for realizing variable diameter turning by machine tools, mainly comprising variable diameter turning tool head units, a power seat unit and a spindle mounting unit. The mechanism enables a turning tool 10 of a CNC machine tool to move along a U-axis direction and rotate around the axis of a spindle 1. Therefore, a workpiece to be machined is subjected to variable diameter turning by active motion of the turning tool 10 without rotational motion of the workpiece, thus realizing machining of a conical surface. A tool changing method is proposed. The implementation of the method mainly involves the motion coordination among various units (the variable diameter turning tool head units, the power seat unit and the spindle mounting unit) of the quick-change mechanism for realizing variable diameter turning, a variable diameter turning tool head grasping mechanism 37, a variable diameter turning tool head unit storing bank 42 and a power seat unit storing plate 39. In addition, through the specific tool changing method, the storage capacity of the machine tool for the variable diameter turning tool head units is expanded, thus the expansibility and compatibility of the machine tool for the variable diameter turning tool head units is further realized.

The technical solution of the present invention is as follows:
A quick-change mechanism for realizing variable diameter turning by machine tools, comprising variable diameter turning tool head units, a power seat unit and a spindle mounting unit;
Each variable diameter turning tool head unit is mainly composed of a spindle tool holder 3, a first bearing 4, a fixing seat 5, a second bearing 6, a lead screw 7, a rotary tool head 8, a lead screw nut 9, a turning tool 10, a tool variable diameter motion plate 11, a first cylindrical gear 12, a second cylindrical gear 13, a third bearing 14, a first bevel gear shaft 15, a first bevel gear 16 and a power transmission shaft 17; the rotary tool head 8 is assembled together with the fixing seat 5 through the first bearing 4 and the second bearing 6, the rotary tool head 8 is further connected with the spindle tool holder 3 to input rotational power to the spindle tool holder 3, and the rotating tool head 8 can perform rotational motion; the power transmission shaft 17 is installed in the fixing seat 5, with one end thereof in interference connection with the first bevel gear 16, and first bevel gear 16 is meshed with the first bevel gear shaft 15; the first bevel gear shaft 15 is fixed in the fixing seat 5 through the third bearing 14, the first bevel gear shaft 15 is fixedly connected with the second cylindrical gear 13, the second cylindrical gear 13 is meshed with the first cylindrical gear 12, the first cylindrical gear 12 is connected with the lead screw 7, the lead screw 7 is connected with the lead screw nut 9, and the lead screw 7 performs rotational motion to drive the lead screw nut 9 to perform rectilinear motion; the tool variable diameter motion plate 11 is connected with the lead screw nut 9, and the tool variable diameter motion plate 11 performs rectilinear motion; and the turning tool 10 is connected with the tool variable diameter motion plate 11, the turning tool 10 performs rectilinear motion, i.e., the motion along a U-axis direction, and rotational motion of the rotary tool head 8 is matched with variable diameter rectilinear motion of the turning tool 10 to realize variable diameter turning of a conical workpiece 36;
The power seat unit is mainly composed of a second bevel gear shaft 18, a fourth bearing 19, a power connection module 20, a fifth bearing 21, a third bevel gear shaft 22, a motor connection bevel gear sleeve 23, a motor 24, a zero-point positioning chuck 26, an antivibration damping concave module 28, a power seat box 29, a sealing strip 30, a second zero-point positioning blind rivet 31, a chuck releasing and air supplying quick plug 32, a gas-sealed quick air supplying plug 33 and a quick-change power supply pin 34; the second bevel gear shaft 18 is used as a power transfer shaft connected with the variable diameter turning tool head unit, and the second bevel gear shaft 18 is connected with the other end of the power transmission shaft 17; the second bevel gear shaft 18 is fixed in the power connection module 20, the second bevel gear shaft 18 is meshed with the third bevel gear shaft 22, and the third bevel gear shaft 22 is fixed in the power connection module 20 through the fourth bearing 19 and the fifth bearing 21; the third bevel gear shaft 22 is further meshed with the motor connection bevel gear sleeve 23, the motor connection bevel gear sleeve 23 is connected with an output shaft of the motor 24, and the motor 24 is fixed to the power seat box 29 to realize power transmission of the motor; the zero-point positioning chuck 26 is installed on the upper surface of the power seat box 29, the chuck releasing and air supplying quick plug 32 and the gas-sealed quick air supplying plug 33 are installed on the lower surface of the power seat box 29, the chuck releasing and air supplying quick plug 32 and the gas-sealed quick air supplying plug 33 are communicated with the zero-point positioning chuck 26, air is supply to the chuck releasing and air supplying quick plug 32 to realize releasing of the zero-point positioning chuck 26, and air is supply to the gas-sealed quick air supplying plug 33 to realize gas-sealed protection of the zero-point positioning chuck 26; the antivibration damping concave module 28 is installed on the upper surface of the power seat box 29; the sealing strip 30 is fixed around the power seat box 29 to form a closed ring and realize sealing of parts in the closed ring; the second zero-point positioning blind rivet 31 is installed on the lower surface of the power seat box 29, and the second zero-point positioning blind rivet 31 is used as a connecting and positioning piece between the power seat unit and a power seat unit storing plate 39; and the quick-change power supply pin 34 is installed on the upper surface of the power seat box 29, and a power cable and an encoder cable of the motor 24 are connected with the quick-change power supply pin 34; and
The spindle mounting unit is mainly composed of a spindle 1, a spindle broach mechanism 2, a zero-point positioning blind rivet 25, an antivibration damping convex module 27 and a quick-change power supply socket 35; the spindle broach mechanism 2 is used for connecting the spindle 1 with the spindle tool holder 3; the antivibration damping convex module 27 is installed on the spindle 1, and is interembedded with the antivibration damping concave module 28 in use to realize connection of the power seat unit with the spindle mounting unit; the zero-point positioning blind rivet 25 is installed on the spindle 1, and is inserted into the zero-point positioning chuck 26 in the power seat unit in use to realize mounting; the quick-change power supply socket 35 is installed in the spindle 1, and is externally connected with the power cable and the encoder cable; and when used, the quick-change power supply socket 35 is interplugged with the quick-change power supply pin 34 to realize power supply and signal docking, and provide power supply and signal feedback for the motor 24 in the power base unit.

A quick-change method of the quick-change mechanism for realizing variable diameter turning by machine tools requires the design of a variable diameter turning tool head unit storing tool magazine, a power seat unit storing auxiliary tool magazine, and an automatic tool grasping and changing mechanism in a machine tool; the variable diameter turning tool head unit storing tool magazine is mainly composed of a variable diameter turning tool head unit storing bank 42 and a storing bank rotation control unit 41, the variable diameter turning tool head unit storing bank 42 is controlled by the storing bank rotation control unit 41 to perform rotational motion, and a plurality of variable diameter turning tool head units are installed on the variable diameter turning tool head unit storing bank 42; the power seat unit storing auxiliary tool magazine is mainly composed of an oil cylinder 38, the power seat unit storing plate 39 and a guide rail slider support system 40, the power seat unit storing plate 39 is used for storing the power seat unit, the power seat unit storing plate 39 is connected with the guide rail slider support system 40, and the power seat unit storing plate 39 is also connected with the oil cylinder 38 and controlled by the oil cylinder 38 to perform telescopic motion; and the automatic tool grasping and changing mechanism, i.e., a variable diameter turning tool head grasping mechanism 37, is a built-in tool changing module of the machine tool.

The quick-change comprises quick change of the variable diameter turning tool head units and quick change of the power seat unit;

The quick change of the variable diameter turning tool head units is realized by grasping the spindle tool holder 3 by the variable diameter turning tool head grasping mechanism 37, and inserting and pulling out the variable diameter turning tool head units along the axis direction of the spindle 1, i.e., inserting a variable diameter turning tool head unit to be loaded, and pulling out a variable diameter turning tool head unit to be unloaded; when a variable diameter turning tool head unit is loaded, the spindle tool holder 3 is inserted into the spindle 1, and the spindle tool holder 3 is tightened by the spindle broach mechanism 2 to complete the connection of rotational motion; at the same time, the power transmission shaft 17 is mated with the bevel gear shaft 18 to realize power transmission to the variable diameter turning tool head unit; and when a variable diameter turning tool head unit is unloaded, the variable diameter turning tool head unit is pulled out by the variable diameter turning tool head grasping mechanism 37 and moved to a fixed position of the variable diameter turning tool head unit storing bank 42, and the spindle tool holder 3 is inserted into a hole for storage.

The quick change of the power seat unit is realized by the coordination of motion position change of the spindle mounting unit and telescopic motion of the power seat unit storing plate 39 of the machine tool, i.e., the second zero-point positioning blind rivet 31 is fixedly installed corresponding to the power seat unit storing plate 39, air is supply to the chuck releasing and air supplying quick plug 32, and the zero-point positioning chuck 26 is released to realize the quick change of the power seat unit.

The present invention has the following beneficial effects: the present invention is the first to configure a zero-point quick-change variable diameter turning device in a turning and milling compound machine tool, and combines a quick-change mechanism, an automatic grasping mechanism and a storing bank to design a specific tool changing method. Therefore, the present invention realizes automatic switching of a variable diameter turning function of the machine tool, expands tool carrying capacity of the machine tool, improves machining efficiency of parts production and manufacturing, is more conducive to ensuring geometric accuracy and surface roughness of a complex curved surface such as a conical surface during turning, and provides a new method for the full-function precision machining of the turning and milling compound machine tool.

### DESCRIPTION OF DRAWINGS

FIG. 1 is a sectional view of a transmission scheme of a quick-change mechanism for realizing variable diameter turning.

FIG. 2 is a local enlarged view of a transmission scheme of a quick-change mechanism for realizing variable diameter turning.

FIG. 3 is a combined structural schematic diagram of a quick-change mechanism for realizing variable diameter turning.

FIG. 4 is a schematic diagram of a motion principle of variable diameter turning.

FIG. 5 is an exploded view of a tool changing method of a quick-change mechanism for realizing variable diameter turning.

In the figures: 1 spindle; 2 spindle broach mechanism; 3 spindle tool holder; 4 first bearing; 5 fixing seat; 6 second bearing; 7 lead screw; 8 rotary tool head; 9 lead screw nut; 10 turning tool; 11 tool variable diameter motion plate; 12 first cylindrical gear; 13 second cylindrical gear; 14 third bearing; 15 first bevel gear shaft; 16 first bevel gear; 17 power transmission shaft; 18 second bevel gear shaft; 19 fourth bearing; 20 power connection module; 21 fifth bearing; 22 third bevel gear shaft; 23 motor connection bevel gear sleeve; 24 motor; 25 zero-point positioning blind rivet; 26 zero-point positioning chuck; 27 antivibration damping convex module; 28 antivibration damping concave module; 29 power seat box; 30 sealing strip; 31 second zero-point positioning blind rivet; 32 chuck releasing and air supplying quick plug; 33 gas-sealed quick air supplying plug; 34 quick-change power supply pin; 35 quick-change power supply socket; 36 conical workpiece; 37 variable diameter turning tool head grasping mechanism; 38 oil cylinder; 39 power seat unit storing plate; 40 guide rail slider support system; 41 storing bank rotation control unit; and 42 variable diameter turning tool head unit storing bank.

### DETAILED DESCRIPTION

Detailed description of the present invention is described below in detail in combination with drawings and the technical solution.

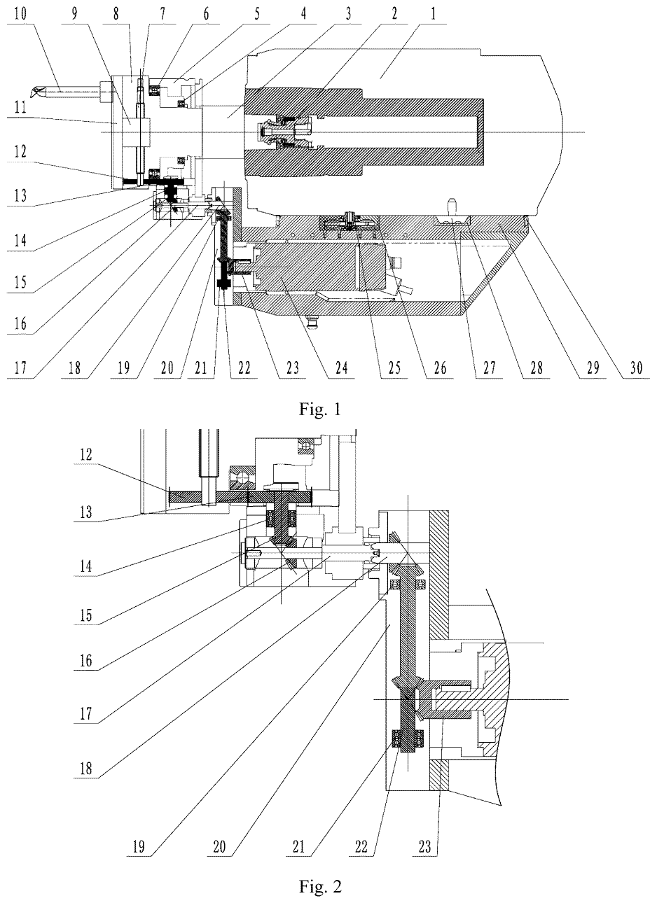

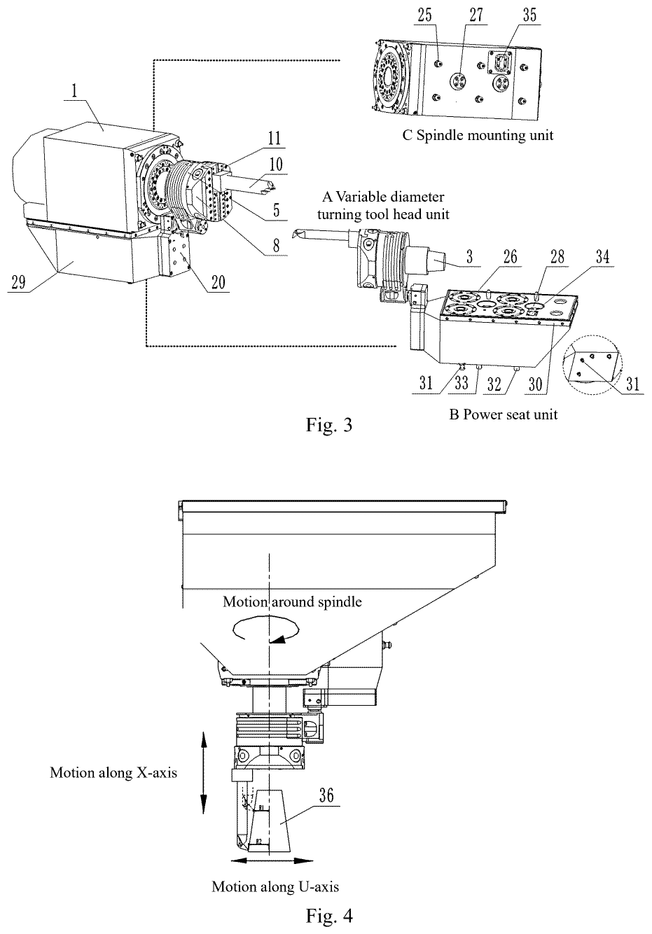

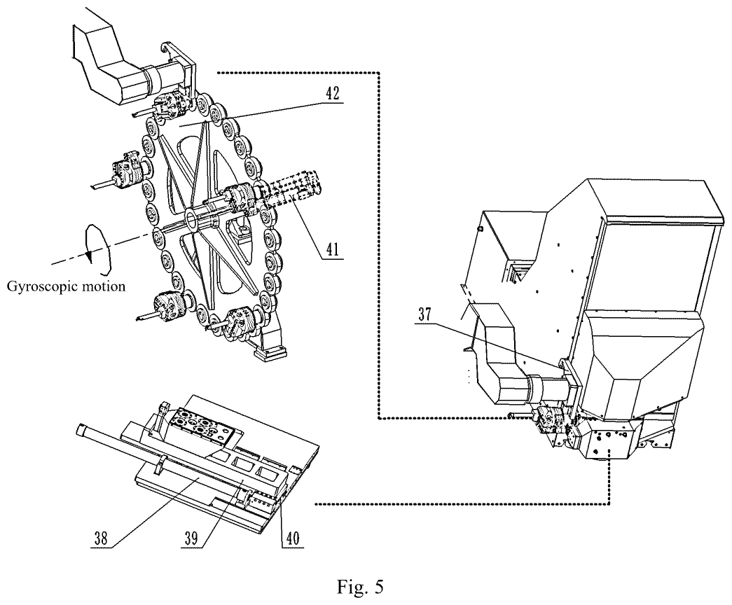

The present invention provides a quick-change mechanism and tool changing method for realizing variable diameter turning by machine tools. A three-dimensional structural diagram of the mechanism is shown in FIG. 1, FIG. 2 and FIG. 3, respectively, a principle of variable diameter turning of the mechanism is shown in FIG. 4, and an exploded view of a tool changing method applied to a machine tool is shown in FIG. 5.

A quick-change mechanism for realizing variable diameter turning by machine tools is mainly composed of variable diameter turning tool head units, a power seat unit and a spindle mounting unit. When a function is activated, the variable diameter turning tool head units, the power seat unit and the spindle mounting unit are connected together.

A tool changing implementation method applied to a machine tool is as follows:

When a workpiece to be machined is featured by a conical shape, a variable diameter turning method is adopted, that is, the workpiece remains stationary, and a turning tool performs rotary machining around an axis of the workpiece. At the same time, the turning tool is fed in a cutting depth direction, and turning radius is changed in a cone generatrix direction.

When a variable diameter turning function is activated, the spindle 1 is moved to a designated position near the power seat unit storing plate 39, oil is supplied to the oil cylinder 38, the power seat unit storing plate 39 extends out, air is supply to the chuck releasing and air supplying quick plug 32 to release the zero-point positioning chuck 26, the spindle 1 is moved to insert the zero-point positioning blind rivet 25 into the zero-point positioning chuck 26, and air supply in the chuck releasing and air supplying quick plug 32 is stopped to realize clamping of the zero-point positioning blind rivet 25 by the zero-point positioning chuck 26. Thus, mounting action of the power seat unit and the spindle mounting unit is completed. When the spindle 1 is moved to a designated tool changing position, mounting of a variable diameter turning tool head unit begins. The variable diameter turning tool head unit storing bank 42 is controlled by the storing bank rotation control unit 41 to rotate, thus to switch a station where the variable diameter turning tool head unit is stored to a tool changing position, the spindle tool holder 3 is grasped by the variable diameter turning tool head grasping mechanism 37, the variable diameter turning tool head unit is pulled out and moved to the designated tool changing position of the spindle 1, the variable diameter turning tool head unit is simultaneously inserted into the spindle 1 and the second bevel gear shaft 18 in the power seat unit, the spindle tool holder 3 is tightened by the spindle broach mechanism 2 in the spindle 1 to complete the connection of rotational motion of the turning tool 10, and the power transmission shaft 17 is inserted into the second bevel gear shaft 18 to complete the connection of rectilinear motion of the turning tool 10. When the variable diameter turning function is paused, the control logic for a tool changing and unloading process is opposite to that for activating the function.

The present invention employs special quick-change structural components for transmission, positioning and connection, and combines the specific tool changing method to realize rapid mounting of the quick-change mechanism for realizing variable diameter turning. Through such a structural method, the expansibility of the tool is realized, and the tool carrying capacity of the tool head of the turning and milling compound machine tool is enhanced. When applied to the turning and milling compound machine tool, the present invention better meets the demand for high-precision machining of special parts in a CNC machine tool and proposes a new structural and control method.

1. A quick-change mechanism for realizing variable diameter turning by machine tools, comprising variable diameter turning tool head units, a power seat unit and a spindle mounting unit;
each variable diameter turning tool head unit is mainly composed of a spindle tool holder, a first bearing, a fixing seat, a second bearing, a lead screw, a rotary tool head, a lead screw nut, a turning tool, a tool variable diameter motion plate, a first cylindrical gear, a second cylindrical gear, a third bearing, a first bevel gear shaft, a first bevel gear and a power transmission shaft; the rotary tool head is assembled together with the fixing seat through the first bearing and the second bearing, the rotary tool head is further connected with the spindle tool holder to input rotational power to the spindle tool holder, and the rotating tool head can perform rotational motion; the power transmission shaft is installed in the fixing seat, with one end thereof in interference connection with the first bevel gear, and first bevel gear is meshed with the first bevel gear shaft; the first bevel gear shaft is fixed in the fixing seat through the third bearing, the first bevel gear shaft is fixedly connected with the second cylindrical gear, the second cylindrical gear is meshed with the first cylindrical gear, the first cylindrical gear is connected with the lead screw, the lead screw is connected with the lead screw nut, and the lead screw performs rotational motion to drive the lead screw nut to perform rectilinear motion; the tool variable diameter motion plate is connected with the lead screw nut, and the tool variable diameter motion plate performs rectilinear motion; and the turning tool is connected with the tool variable diameter motion plate, the turning tool performs rectilinear motion, i.e., the motion along a U-axis direction, and rotational motion of the rotary tool head is matched with variable diameter rectilinear motion of the turning tool to realize variable diameter turning of a conical workpiece;
the power seat unit is mainly composed of a second bevel gear shaft, a fourth bearing, a power connection module, a fifth bearing, a third bevel gear shaft, a motor connection bevel gear sleeve, a motor, a zero-point positioning chuck, an antivibration damping concave module, a power seat box, a sealing strip, a second zero-point positioning blind rivet, a chuck releasing and air supplying quick plug, a gas-pin; the second bevel gear shaft is used as a power transfer shaft connected with the variable diameter turning tool head unit, and the second bevel gear shaft is connected with the other end of the power transmission shaft; the second bevel gear shaft is fixed in the power connection module, the second bevel gear shaft is meshed with the third bevel gear shaft, and the third bevel gear shaft is fixed in the power connection module through the fourth bearing and the fifth bearing; the third bevel gear shaft is further meshed with the motor connection bevel gear sleeve, the motor connection bevel gear sleeve is connected with an output shaft of the motor, and the motor is fixed to the power seat box to realize power transmission of the motor; the zero-point positioning chuck is installed on the upper surface of the power seat box, the chuck releasing and air supplying quick plug and the gas-sealed quick air supplying plug are installed on the lower surface of the power seat box, the chuck releasing and air supplying quick plug and the gas-sealed quick air supplying plug are communicated with the zero-point positioning chuck, air is supply to the chuck releasing and air supplying quick plug to realize releasing of the zero-point positioning chuck, and air is supply to the gas-sealed quick air supplying plug to realize gas-sealed protection of the zero-point positioning chuck; the antivibration damping concave module is installed on the upper surface of the power seat box; the sealing strip is fixed around the power seat box to form a closed ring and realize sealing of parts in the closed ring; the second zero-point positioning blind rivet is installed on the lower surface of the power seat box, and the second zero-point positioning blind rivet is used as a connecting and positioning piece between the power seat unit and a power seat unit storing plate; and the quick-change power supply pin is installed on the upper surface of the power seat box, and a power cable and an encoder cable of the motor are connected with the quick-change power supply pin; and
the spindle mounting unit is mainly composed of a spindle, a spindle broach mechanism, a zero-point positioning blind rivet, an antivibration damping convex module and a quick-change power supply socket; the spindle broach mechanism is used for connecting the spindle with the spindle tool holder; the antivibration damping convex module is installed on the spindle, and is interembedded with the antivibration damping concave module in use to realize connection of the power seat unit with the spindle inserted into the zero-point positioning chuck in the power seat unit in use to realize mounting; the quick-change power supply socket is installed in the spindle, and is externally connected with the power cable and the encoder cable; and when used, the quick-change power supply socket is interplugged with the quick-change power supply pin to realize power supply and signal docking, and provide power supply and signal feedback for the motor in the power base unit.

2. The quick-change mechanism for realizing variable diameter turning by machine tools according to claim 1, wherein
a quick-change method of the quick-change mechanism for realizing variable diameter turning by machine tools requires the design of a variable diameter turning tool head unit storing tool magazine, a power seat unit storing auxiliary tool magazine, and an automatic tool grasping and changing mechanism in a machine tool; the variable diameter turning tool head unit storing tool magazine is mainly composed of a variable diameter turning tool head unit storing bank and a storing bank rotation control unit, the variable diameter turning tool head unit storing bank is controlled by the storing bank rotation control unit to perform rotational motion, and a plurality of variable diameter turning tool head units are installed on the variable diameter turning tool head unit storing bank; the power seat unit storing auxiliary tool magazine is mainly composed of an oil cylinder, the power seat unit storing plate and a guide rail slider support system, the power seat unit storing plate is used for storing the power seat unit, the power seat unit storing plate is connected with the guide rail slider support system, and the power seat unit storing plate is also connected with the oil cylinder and controlled by the oil cylinder to perform telescopic motion; and the automatic tool grasping and changing mechanism, i.e., a variable diameter turning tool head grasping mechanism, is a built-in tool changing module of the machine tool.

3. The quick-change method of the quick-change mechanism for realizing variable diameter turning by machine tools according to claim 2, wherein the quick-change method comprises quick change of the variable diameter turning tool head units and quick change of the power seat unit.

4. The quick-change method according to claim 3, wherein the quick change of the variable diameter turning tool head units is realized by grasping the spindle tool holder by the variable diameter turning tool head grasping mechanism, and inserting and pulling out the variable diameter turning tool head units along the axis direction of the spindle, i.e., inserting a variable diameter turning tool head unit to be loaded, and pulling out a variable diameter turning tool head unit to be unloaded; when a variable diameter turning tool head unit is loaded, the spindle tool holder is inserted into the spindle, and the spindle tool holder is tightened by the spindle broach mechanism to complete the connection of rotational motion; at the same time, the power transmission shaft is mated with the bevel gear shaft to realize power transmission to the variable diameter turning tool head unit; and when a variable diameter turning tool head unit is unloaded, the variable diameter turning tool head unit is pulled out by the variable diameter turning tool head grasping mechanism and moved to a fixed position of the variable diameter turning tool head unit storing bank, and the spindle tool holder is inserted into a hole for storage.

5. The quick-change method according to claim 3, wherein the quick change of the power seat unit is realized by the coordination of motion position change of the spindle mounting unit and telescopic motion of the power seat unit storing plate of the machine tool, i.e., the second zero-point positioning blind rivet is fixedly installed corresponding to the power seat unit storing plate, air is supply to the chuck releasing and air supplying quick plug, and the zero-point positioning chuck is released to realize the quick change of the power.
